(19) United States
(12) Patent Application Publication
(10) Pub. No.: US 2025/0050157 A1
(43) Pub. Date: Feb. 13, 2025

(54) Power Generating Exercise Apparatus with User Adjustable Electrical Power and Method Thereof

(71) Applicant: EQUIPEMENT OFF THE GRID INC., Saint-Bruno-de Montarville (CA)

(72) Inventors: Sebastien Brunelle-Jestin, Longueuil, QC (CA); Yves Lemieux, Montreal, QC (CA); Eric Dube, Saint-Bruno-de-Kamouraska, QC (CA); Carl Lavertu, Beloeil, QC (CA)

(21) Appl. No.: 18/721,487

(22) PCT Filed: Dec. 23, 2022
(86) PCT No.: PCT/CA2022/051897

§ 371 Date: Jun. 18, 2024

Related U.S. Application Data
(60) Provisional application No. 63/265,983, filed on Dec. 23, 2021.

(51) Int. Cl. A63B 21/005; A63B 22/06

(52) U.S. Cl. CPC A63B 21/0053; A63B 21/0056; A63B 22/0605

(57) ABSTRACT

An exercise apparatus comprising a frame, a rotating component rotatably connected to the frame, said component being adapted to rotate in response to operation of the apparatus by a user, a generator mechanically connected to the rotating component for generating an electrical power signal at an output thereof, a power electrical circuit connected to the output of the generator for converting the electrical power signal into a standard network electrical output signal adapted to match the voltage, frequency and phase of a local electrical network, a current sensor for sensing a current of the output signal, a communication and control circuit comprising input means to enable the user to specify a desired power output setting through input means; and a servo control circuit to accordingly vary a value of an output signal delivered by the generator.

### CROSS-REFERENCE TO RELATED APPLICATIONS

The present patent application claims the benefits of priority of U.S. Patent Application No. 63/265,983, entitled “POWER GENERATING EXERCISE APPARATUS WITH USER ADJUSTABLE ELECTRICAL POWER AND METHOD THEREOF” and filed at the United States Patent and Trademark Office on Dec. 23, 2021, the content of which is incorporated herein by reference.

### FIELD OF THE INVENTION

The present invention generally relates to exercising apparatuses and methods but more particularly to an exercising apparatus and method for converting human mechanical power to electrical power to be supplied to an electrical network.

### BACKGROUND OF THE INVENTION

Exercising apparatuses such as training cycles are well known means of creating a mechanical resistance to enable a user to exert energy and develop strength and/or endurance. The energy thereby spent by the user is most often dissipated as heat in the system. However, some apparatuses of the prior art have been devised to harvest the mechanical energy provided by the user, converting it into electrical power stored in a battery and/or used to power or charge a small personal electronic device such as a user's smart phone or music player. Typically, in these systems, a rotary means activated by the user is coupled to a generator connected to an electricity storage means and a power outlet connector. Variation of the power or effort to be provided by the user is typically enabled through a user adjustable electrical (induction) brake or variable resistive load supplied by a generator.

One way or another, significant electrical power can be generated by the user on such exercising apparatuses. The generated electrical power may be greater than electrical power needs of the individual. However, a significant portion of the spent mechanical work is still wasted as heat. Therefore, some apparatuses have been adapted to “upload” the most part of the generated electrical energy to an electrical network that can absorb all that available electrical energy in a useful way. For example, to reduce the energy drawn from the public services (grid) or feed the grid to generate savings or a source of revenue.

U.S. Pat. No. 9,067,099 granted to Beard et al. discloses an apparatus, system and associated method for generating power from an exercise equipment. In the apparatus disclosed by Beard, a generator has a rotor connected to a user activated rotating component to produce electrical current at an output. The current can be used to charge a battery or device or alternatively, power may be directed to an electrical grid.

As emphasized in that disclosure, a challenge that such systems are facing is to adjust the amount of work as desired by the exercising person by varying the load at the output of the generator. To that end, Beard teaches the use of an electrical resistor or an electrical brake. While this technique may provide the desired work adjustment, it fails to harvest a maximum of energy by varying the amount of energy transferred to the electrical grid to provide a variable load at the generator and in turn a variable work requirement by the exercising user.

There is therefore a need for an improved exercising apparatus and method for converting human mechanical power to electrical power to be supplied to an electrical network.

### SUMMARY OF THE INVENTION

The shortcomings of the prior art are generally mitigated by an exercise apparatus enabling a user to select or specify the level of power to be produced and supplied to an electrical network and in turn determine the level of mechanical work that the user will be required to provide while exercising and thereby addressing the limitations and drawbacks of the prior art devices.

In order to do so, according to an embodiment, there is generally provided an exercise apparatus comprising a frame, a rotating component rotatably connected to the frame, said component being adapted to rotate in response to operation of the apparatus by a user, a generator mechanically connected to the rotating component for generating electrical power signal at an output thereof, a power electrical circuit connected to the output of the generator for converting the electrical power signal into a standard network electrical output signal adapted to be “uploaded” to an electrical network (aka utility grid), a current sensor for sensing a current of the output signal, a communication and control circuit comprising input means to enable the user to specify a desired power output setting through input means, and a servo control circuit to accordingly vary a value of an output signal delivered by the generator.

According to an aspect, the apparatus further comprises a power cord connected at an output of the power electrical circuit and a standard plug terminal to connect the apparatus into a standard AC outlet of a dwelling such as a gym.

According to an aspect, input means comprise a button switch to increase the desired power setting and a button switch to decrease the desired power setting.

According to an aspect, the communication and control circuit further comprises a display mounted on the frame to enable the user to monitor the electrical power outputted by the apparatus and other training statistics.

According to an aspect, the communication and control circuit further comprises a communication circuit adapted to transmit and receive data to/from a remote server through a local WIFI router.

According to an aspect, the electrical signal produced at the output of the generator is a three-phase alternative current (AC) signal.

According to an aspect, the power electrical circuit comprises a rectifying and filter stage, a digital signal processor for producing pulse width modulated (PWM) signals, a DC to AC buck/boost converting stage to convert the PWM signals to an output electrical signal matching the voltage and frequency of the network, and a zero-crossing circuit to enable matching of a phase of the output signal with that of the network signal.

According to a further embodiment, there is provided an exercising system comprising an apparatus as described above and further comprising a WIFI router, a WEB interface application and a server providing an Internet of Things (IoT) computer and software environment for communication with the apparatus and a smart phone and data storage.

According to an aspect, the WEB application comprises a personal smart phone application.

According to an aspect, the server is a remote cloud server and the environment is an AWS Cloud environment.

According to an aspect, the smart phone comprises a computer application for enabling the user to communicate with the server through the WIFI router or a cellular network and gather and display statistical data related to a performed exercise, such as generated power (instant, mean, max) and energy, speed, elapsed exercise time.

The apparatus is therefore adapted to regulate the electrical power produced and the human work required according to a power setting provided by the user. There is further provided a system comprising such an apparatus, a Wi-Fi router, a personal smart phone application and a server providing an Internet of Things (IoT) environment for communication with the apparatus and a smart phone and data storage.

In a further aspect of the invention, an exercise apparatus is provided. The apparatus comprises a frame, a rotating component rotatably connected to the frame, said component rotating in response to operation of the apparatus by a user, an electric generator operatively connected to the rotating component for generating an electrical output signal, a power electrical converter connected to the output of the generator, the power electrical converter converting the electrical power signal into an electrical output signal matching voltage, frequency and phase of an electrical network, a current sensor for sensing a current of the output signal, a communication device configured to set a desired power output setting; and a servo controller configured to vary a value of the output signal of the generator.

In yet another aspect of the invention, a method for converting rotary movement into electrical power and to feed the electrical power to an electrical network is provided. The method comprises setting a desired power output setting, rotating a rotary element, varying the magnetic resistance of the rotatory element based on the desired power output setting, converting the rotation of the rotatory element into an electrical power signal, and synchronizing the electrical power signal with a signal of an electrical network.

According to a further aspect of the invention an exercise apparatus is provided. The exercise apparatus comprises a frame, a rotating component rotatably connected to the frame, the rotating component rotating in response to operation of the apparatus by a user, an electric generator operatively connected to the rotating component for generating an electrical output signal, a power electrical converter connected to the output of the generator to convert the electrical power signal into an electrical output signal matching voltage, frequency and phase of an electrical network, a current sensor for measuring a current of the output signal of the generator, a computerized device configured to set a desired power output setting of the exercise apparatus and a servo controller configured to vary a value of the output signal of the generator as a function of the set desired power output setting.

The computerized device may comprise a user interface in data communication with the servo controller and configured to set the desired power setting. The current sensor may be in communication with the servo controller to communicate the sensed current to the servo controller.

The servo controller may be configured to compare actual output power of the apparatus with a user power setting set with the user interface based on the sensed current.

The exercise apparatus may further comprise a case housing the rotating component and the electric generator. The exercise apparatus may further comprise a magnetic brake controlling the resistance of the rotating component. The generator of the exercise apparatus may be a disk-type generator. The disk-type generator may generate a three-phase AC current.

The power electrical converter may be a pair of buck/boost converters in a Flyback configuration. The computerized device may compare the measured output of the electrical generator to the desired power output setting.

The exercise apparatus may comprise an injection circuit matching the phase of the output signal to the phase of the voltage of the electrical network and may further comprise a digital signal processor to generating pulse-width-modulated signals. The exercise apparatus may further comprise an electronic circuit to convert the output signal into a sine wave output power. The computerized device may monitor the electrical power outputted by the apparatus and providing other training statistics.

In yet another embodiment, a method to convert rotary movement into electrical power and to feed an electrical network is provided. The method comprises setting a desired power output setting, rotating a rotary element, varying an electronic resistance of the rotatory element based on the desired power output setting, converting the mechanical energy produced by the rotation of the rotatory element into an electrical power signal based on the desired power output setting and synchronizing the electrical power signal with a signal of an electrical network.

The method may further comprise remotely setting the desired power output setting and may further comprise rotating pedals of the rotary element to generate the mechanical energy. The method may further comprise varying a magnetic resistance of the rotary element to vary the mechanical resistance of the rotary element. The conversion of the mechanical energy created by the rotation into electrical power may be performed by generating a three phase AC current.

The synchronization of the electrical power signal with a signal of an electrical network further may comprise processing the generated AC current into a pulse-width-modulated signal and injecting said signal into the electrical network.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is an isometric view of an embodiment of an exercising apparatus in accordance with the principles of the present invention.

FIG. 2 is an isometric view of an embodiment of handle bars holding a computerized device for an exercising apparatus in accordance with the principles of the present invention.

FIG. 3 is a schematic representation of an embodiment of an exercising system in accordance with the principles of the present invention.

FIG. 4 is a schematic block diagram of an embodiment of a power electrical circuit and a communication and control electrical circuit in accordance with the principles of the present invention.

It will be noted that throughout the appended drawings, like features are identified by like reference numerals.

### DETAILED DESCRIPTION OF THE INVENTION

A novel power generating exercise apparatus with user adjustable electrical power and method thereof will be described hereinafter. Although the invention is described in terms of specific illustrative embodiments, it is to be understood that the embodiments described herein are by way of example only and that the scope of the invention is not intended to be limited thereby.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as,” or the like) provided herein, is intended merely to better illuminate the exemplary realizations and does not pose a limitation on the scope of the realizations. No language in the specification should be construed as indicating any unclaimed element as essential to the practice of the realizations.

In the following description, it is understood that terms such as “first”, “second”, “top”, “bottom”, “above”, “below”, and the like, are words of convenience and are not to be construed as limiting terms.

The terms “top”, “up”, “upper”, “bottom”, “lower”, “down”, “vertical”, “horizontal”, “interior” and “exterior” and the like are intended to be construed in their normal meaning in relation with normal installation of the product.

Again, it shall be noted that throughout the appended drawings, like features are identified by like reference numerals.

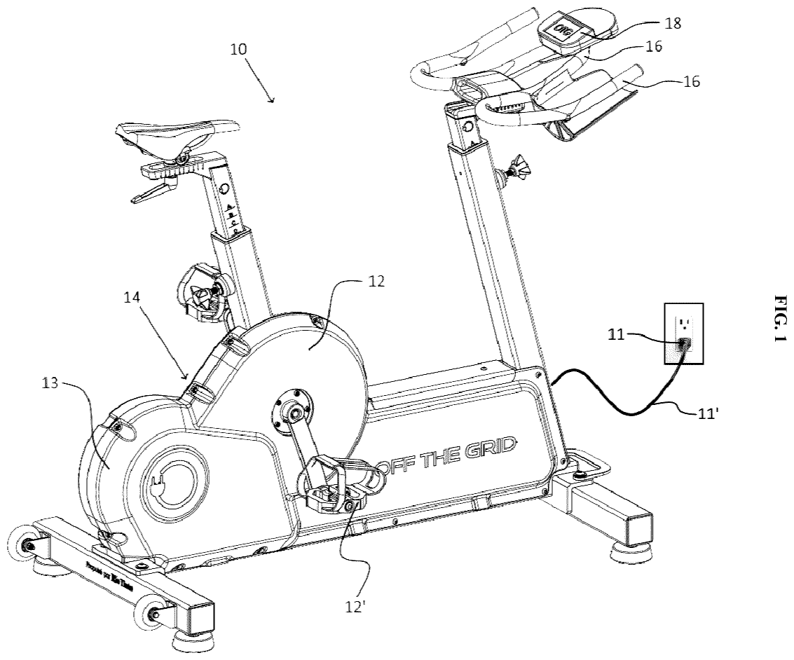

Referring now to FIG. 1, according to a first embodiment, there is provided an exercising apparatus 10, represented as an exercising bike 10 in the exemplary description herein, for use by a person, aka intended user or user, for training under one or more desired levels of effort, aka power or work. The exercising bike 10 may be used in a commercial environment such as but not limited to a gym, coworking space. Understandably, the said exercising bike 10 may also be used at home. The bike 10 is adapted to convert the mechanical (i.e., kinetic) energy, aka work, supplied by the user to electrical power matching the voltage, frequency and phase of the electrical network of a dwelling, i.e., a gym or house, represented here by the standard alternative current (AC) outlet AC. The apparatus 10 is electrically connected to an electrical network, such as utility grid. In some embodiments, the apparatus 10 comprises an electrical power cord 11 and a plug 11′ enabling the electrical connection of the apparatus to the outlet electrically connected to the electrical network. The current of the electrical network is typically AC. The said electrical connection generally aims at enabling transfer of the electrical power generated by the apparatus 10 to an electrical network. The upstream transfer of electrical power compensates or reduces the power and energy drawn from the electrical network, such as the public utility grid. As a consequence, the user may potentially generate savings. In certain embodiments, a group of exercising apparatus 10 connected to the electrical network may generate enough electrical power to return electricity to the grid and may generate revenues in accordance with the uploaded electrical energy.

The exercising apparatus 10 comprises a rotary element 12 connected to the pedal 12′ and a corresponding second pedal forming a pair of pedals with the pedal 12′, (not shown in the present figures). The rotary element 12 may be actuated by the user while exercising. The rotary element 12 is mechanically or operatively connected to a disk rotor of a disk type generator 13. The generator 13 may be any standard flat disk generator generally comprising at least one rotor disk having a series of permanent magnets and being rotatably assembled to a stator comprising at least one flat disk provided with coil elements and being fixedly mounted to a frame portion 14 of the apparatus. Rotating the element 12 by using the pedals 12′ therefore causes rotation of the rotor with respect to the stator part of the generator 13 which induces AC voltage at the inductor coils outputs. In this exemplary embodiment, the generator 13 generates a three-phase output power of about 200 volts @ 1000 RPM. The capacity of the selected generator allows generation of up to about 350 W. Understandably, in other embodiments, the generator 13 may generate a single-phase current having any suitable power.

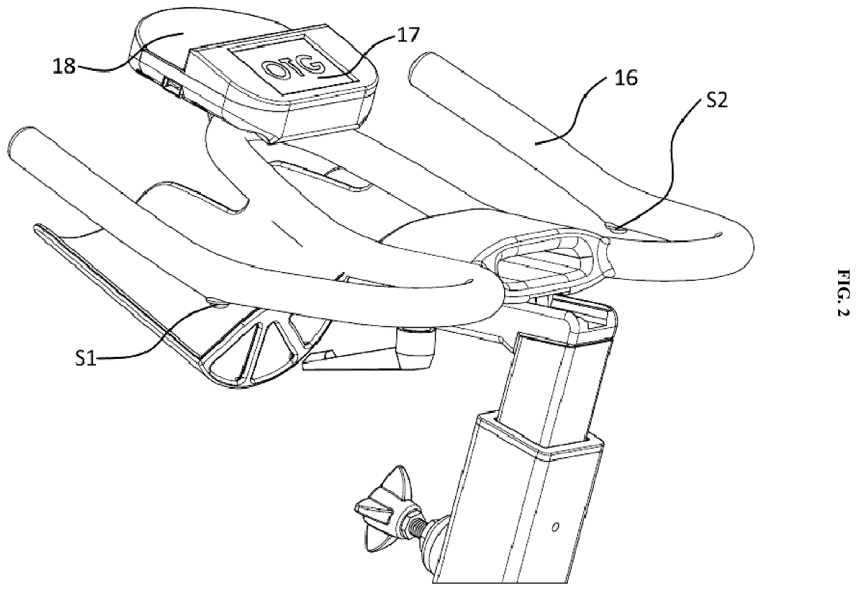

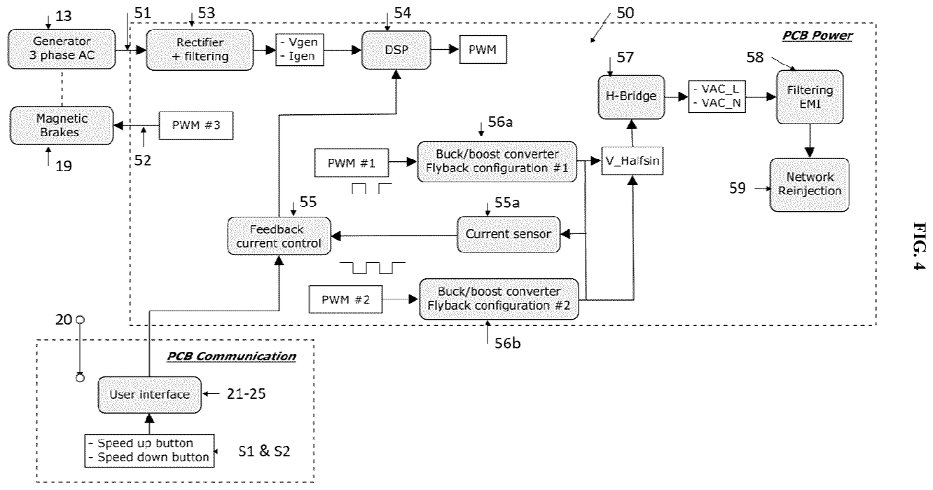

The generated power is function of the rotary speed of the rotary element 12 and/or of the torque exerted by the pedaling user. The exercising apparatus 10 may further comprise power adjustment mechanism. In the illustrated embodiment of FIG. 2, the power adjustment mechanism comprises a first S1 and second S2 switches. The user may specify a desired power setting by operating the first switch S1 to increase the power setting or by operating the second switch S2 to decrease the said power, as shown in FIGS. 2 and 4. In some embodiment, the switches S1 and S2 may be actuated by pressing a button. Alternatively, the handlebar branches 16 may comprise discrete switches.

In yet another embodiment, the switches S1 and S2 may be located on the handlebar 16 and may thus be accessible through natural and ergonomic positioning of the hands of the user when the exercising apparatus 10 is in use. Understandably, the switches S1 and S2 may be located anywhere on the handlebar 16 or on the exercising apparatus 10.

The exercising apparatus 10 may further comprise an LCD display 17 further shown in FIG. 2. The LCD display 17 may be configured to display the selected power setting (see also on the controller board on the schematic of FIG. 4). The exercising apparatus 10 may further comprise a personal smart phone holder 18. The personal smart phone holder 18 may be secured to the handlebar 16 for holding a smart phone P or another computerized device configured to execute an application and to display statistics, such as but not limited to instant, average and maximum power and speed, elapsed exercising time and generated energy.

As shown in FIG. 2, an embodiment of the phone holder 18 is illustrated. Understandably, the phone holder 18 of FIG. 1 may have any other shapes and dimensions. In the illustrated embodiment, the phone holder 18 of FIG. 1 is a clip. In such embodiment, the phone holder 18 takes limited space on the apparatus 10.

The phone holder 18 illustrated at FIG. 2 is embodied as a stand. When embodied as a stand, the phone holder 18 may hold the computerized device P. The overall volume of the stand is typically greater than the volume of the above describe clip. Understandably, any other shape of phone holder 18 may be used. It may be appreciated that the phone holder 18 may also house the LCD display 17 as seen in FIG. 2.

Referring now to FIG. 1, another embodiment of the exercising apparatus 10 is shown. The embodied apparatus 10 comprises a rotary element 12 having a larger diameter than the diameter of the disk of the generator 13. The change in ratio between the diameters of the rotary element 12 and the generator 13 may provide different results of energy generation. Thus, the ratio may be designed accordingly in order to provide specific levels of energy generation for a given quantity of pedal 12′ turns by the user. The frame portion 14 may further house any one or both of the rotary element 12 and generator 13. The frame portion 14 housing one or both of the parts (12, 13) may prevent dirtying of the components (12, 13) and may also prevent injuries of the user or of other people or animals around.

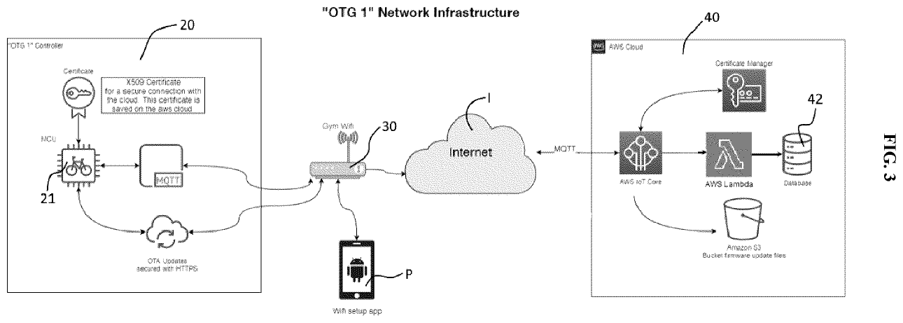

Referring now to FIG. 3, a schematic representation of an embodiment of a network infrastructure is illustrated. The network infrastructure along with the apparatus 10 may represent a complete power generating exercising system according to an embodiment.

The system generally comprises a controller 20, such as a control circuit board 20, a wireless network hub 30, such as but not limited to a WIFI router 30 in data communication with a data network I, such as the Internet I, a computerized device P connected to the network I, such as but not limited to a smart phone, a tablet or a computer and a remote server 40, such as but not limited to a web server, connected to the data network. The server 40 may be configured to providing an Internet of Things (IoT) computer and software environment, such as cloud-based server environment. In the illustrated embodiment, the cloud-based server environment is the AWS™ Cloud environment. In some embodiments, a service provider may sell or rent a group of apparatus 10 to the gym and provide access to its cloud-based server environment through a proprietary WEB application and any appropriate licensing agreements to enable proper operation and use of the apparatus 10. In such embodiment, the computerized devices P are configured to communicate with the server through the data network I. In the illustrated embodiment, Message Queuing Telemetry Transport (MQTT) network protocol is used to transport messages over the Internet between the devices (any bike 10 of any group and the server 40). The server 40 may provide data storage capacity to maintain a database 42 grouping all statistical data of the bikes 10 and service users.

The bike 10 may comprise one or more sensors or capturing devices to detect data related to the user, such as pedaling frequency, generated electrical power, etc. The captured data may be communicated over the network and stored by the server 40. The computerized device P or similar device may be programmed to execute an application software to communicate with the server 40 and to retrieve data related to exercising events of one or more bikes 10.

Referring now to FIG. 4, an embodiment of an electronic circuitry of the apparatus 10 is illustrated. The electronic circuitry generally comprises a communication and control electrical circuit board 20 and a power electrical circuit board 50. The power board 50 comprises an input 51 electrically connected to the output of the generator 13 and an output 52 electrically connected to a magnetic brake 19. The magnetic brake 19 may be controlled to increase the resistance at the rotary element 12. In some embodiment, in the event where the selected power setting selected is larger than the maximum power that can be generated by the generator 13, the resistance of the rotary element 12 may be increased, such as by activating the magnetic brake 19. The resistance may be increased based on the angular speed or rotation of the rotary element (aka RPM). The input 51 feeds the generator output signal to a rectifying and filtering circuit 53 to provide a rectified DC signal (DC voltage and current), which is fed to a digital signal processor (DSP) 54 to generate three pulse-width-modulated signals (PWM=PWM #1; PWM #2 and PWM #3).

The communication and control circuit board 20 may comprise the communication circuitry and software as aforementioned, and a user interface 21 connected to the switches S1 and S2 to determine the desired power setting and in turn, the effort to be provided by the user.

Referring now to FIG. 3, a detailed schematic of an exemplary circuit is illustrated. The user interface 21 comprises an output connected to a current servo control 55 of the power board 50. The user interface 21 is configured to provide the desired power setting to the servo control circuit 55. The current servo control 55 further comprises an input connected to a current sensor 55a providing a signal generally proportional to the output current (aka output power) delivered at an output stage of the power board 50. Thereby, the current servo control 55 may be configured to compare actual output power and the user power setting. The current servo control 55 is further configured to send a signal to the DSP circuit 54 to determine the duty cycle of the PWM #1 and PWM #2 signals that will yield the desired power produced at the output stage. The desired power produced at the output stage generally conditions the load as seen by the generator, the torque at the rotary element 12 and the effort experienced by the user. A third pulse-width-modulated signal PWM #3 is generated to feed the magnetic brake 19 as required to provide additional torque at the rotary element 12 and requiring additional effort from the user without exceeding the specified power setting to be generated at the power board output.

The power circuit board 50 further comprises a pair of buck/boost converters in a Flyback configuration 56a and 56b. The pair of buck/boost converters 56a, 56b generally aims at generating proper output power from the PWM #1 and PWM #2 signals. The converter 56a converts PWM #1 signal into a first (positive) alternance of a 60 Hz AC sine wave power signal, and the converter 56b converts PWM #2 signal into a second (negative) of a 60 Hz AC sine wave power signal. The two converted signals are boosted to an appropriate peak voltage substantially equal to a line voltage of the AC outlet AC of the electrical network. The power circuit board 50 further comprises a current sensor 53 configured to monitor converted signals. The said converted signals are fed to an H-Bridge 57 to be added (aka assembled) to form a full sine wave output power signal that is electromagnetic interference (EMI). The power circuit board 50 further comprises an EMI filter circuit 58 configured to filter the full sine wave output power signal. The power circuit board 50 further comprises an injection circuit 59 adapted to receive the filtered signal. The power circuit board 50 may further comprises zero-crossing circuitry adjusting the phase of the output signal to match the phase of the line voltage at AC. The injection circuit 59 may thus be connected to the power cord 11 to enable injection of the generated electrical power into the electrical network.

The circuit board 20 preferably comprises the microprocessor controller unit (MCU) 21 configured to receive signals from the up and down switches S1 and S2 through interfaces 23 and 24 respectively, and configured to handle communications with the power circuit board 50 through the communication interfaces 22 and 25. The MCU 21 further controls a USB charging circuit 26 to supply a charging port at the smart phone support 18.

In some embodiments, the electronic circuit comprises a central processor unit (CPU) and the feed system. The CPU is generally configured to perform the digital signal processing 54, to control the current servo control 55 and to handle communications with the control board 20.

In yet other embodiments, the circuit comprises the current sensor 55a, the rectifier 53, and the buck/boost flyback converted 56a and 56b.

In further embodiments, the circuit 20 may comprise the full bridge AC circuit 57. The full bridge AC circuit 57 comprises the phase shifting circuitry and EMI filtering 58 and 59 of the output power signal.

The protection circuit 54′ may be configured to produce the PWM #3 signal to feed the electromagnetic brake 19.

In some embodiments, the training person (aka user) may log or authenticate with the server 40 using a computerized device P. Once logged to the server 40 through a network infrastructure, such as but not limited to the one illustrated in of FIG. 3, the user may use the power adjustment mechanism, such as the plate button 15 to actuate either switch S1 and/or S2, to set a desired power level. The power level may be displayed on the LCD display 17.

When the user is pedaling, the system calculates the actual generated power. The calculation is a function of the output of the generator. The resulting actual power may be displayed, as well as other statistics, in real time. A computerized device P may be used by the user to connect to the server 40 of the service provider to access statistics about the training session associated with the logged account.

Pedaling imparts a rotary movement to the rotary element 12 through the pedals 12′. Such rotary movement in turn causes the generator 13 to generate a three-phase AC current at an output thereof, being fed to a rectifying stage 53 at an input of the power electrical circuit board 50. The so rectified DC voltage and current are then processed by the digital signal processor (DSP) 54 to generate pulse-width-modulated (PWM) signals sent to buck/boost converters 56, H-bridge 57, filtering 58 and final signal conditioning 59 to enable injection of the generated AC power into the local electrical network through electrical cord 11 and AC outlet AC. The processing of the rectified electrical power signal by the digital signal processor 54 is typically performed based on the specified power requirement inputted by the user and communicated to the board 50 by the communication and control board 20, and on the actual value of the generated AC output signal as monitored through the current sensor 55a. Therefore, the DSP 54 tailors the duty cycle of the PWM #1 and PWM #2 signals so that the output power matches the power setting specified by the user. Thereby, the electrical load at the output of the generator 13 is being determined, and so is the mechanical load sensed by the user at pedal 12′.

Accordingly, it is believed in view of the above description of the preferred embodiments, that the instant power generating exercise apparatus with user adjustable electrical power and the associated system address the limitations and drawbacks of the prior art devices, apparatuses and systems and provide an appropriate solution to training persons, gym owners and other users to harvest an optimal amount of electrical energy from the kinetic energy spent in exercising equipment.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An exercise apparatus comprising:
a frame;
a rotating component rotatably connected to the frame, the rotating component rotating in response to operation of the apparatus by a user;
an electric generator operatively connected to the rotating component for generating an electrical output signal;
a power electrical converter connected to the output of the generator to convert the electrical power signal into an electrical output signal matching voltage, frequency and phase of an electrical network;
a current sensor for measuring a current of the output signal of the generator;
a computerized device configured to set a desired power output setting of the exercise apparatus; and
a servo controller configured to vary a value of the output signal of the generator as a function of the set desired power output setting.

2. The exercise apparatus of claim 1, the computerized device comprising a user interface in data communication with the servo controller and configured to set the desired power setting.

3. The exercise apparatus of claim 2, the current sensor being in communication with the servo controller to communicate the sensed current to the servo controller.

4. The exercise apparatus of claim 3, the servo controller being configured to compare actual output power of the apparatus with a user power setting set with the user interface based on the sensed current.

5. The exercise apparatus of claim 1 further comprising a case housing the rotating component and the electric generator.

6. The exercise apparatus of claim 1 further comprising a magnetic brake controlling the resistance of the rotating component.

7. The exercise apparatus of claim 1, the generator being a disk-type generator.

8. The exercise apparatus of claim 6, the disk-type generator generating a three-phase AC current.

9. The exercise apparatus of claim 1, the power electrical converter being a pair of buck/boost converters in a Flyback configuration.

10. The exercise apparatus of claim 1, the computerized device comparing the measured output of the electrical generator to the desired power output setting.

11. The exercise apparatus of claim 1 comprising an injection circuit matching the phase of the output signal to the phase of the voltage of the electrical network.

12. The exercise apparatus of claim 1 further comprising a digital signal processor to generating pulse-width-modulated signals.

13. The exercise apparatus of claim 1 further comprising an electronic circuit to convert the output signal into a sine wave output power.

14. The exercise apparatus of claim 1, the computerized device monitoring the electrical power outputted by the apparatus and providing other training statistics.

15. A method to convert rotary movement into electrical power and to feed an electrical network comprising:
setting a desired power output setting;
rotating a rotary element;
varying an electronic resistance of the rotatory element based on the desired power output setting;
converting the mechanical energy produced by the rotation of the rotatory element into an electrical power signal based on the desired power output setting; and
synchronizing the electrical power signal with a signal of an electrical network.

16. The method of claim 15 further comprising remotely setting the desired power output setting.

17. The method of claim 15 further comprising rotating pedals of the rotary element to generate the mechanical energy.

18. The method of claim 15 further comprising varying a magnetic resistance of the rotary element to vary the mechanical resistance of the rotary element.

19. The method of claim 15, wherein the conversion of the mechanical energy created by the rotation into electrical power is performed by generating a three phase AC current.

20. The method of claim 15, wherein the synchronization of the electrical power signal with a signal of an electrical network further comprises processing the generated AC current into a pulse-width-modulated signal and injecting said signal into the electrical network.
